(19) United States
(12) Patent Application Publication
(10) Pub. No.: US 2015/0155107 A1
(43) Pub. Date: Jun. 4, 2015

(54) LITHIUM ION CAPACITOR

(71) Applicant: SUMITOMO ELECTRIC INDUSTRIES, LTD., Osaka-shi, Osaka (JP)

(72) Inventors: Kazuki Okuno, Itami-shi (JP); Tomoharu Takeyama, Itami-shi (JP); Masatoshi Majima, Itami-shi (JP)

(21) Appl. No.: 14/412,301

(22) PCT Filed: Jul. 1, 2013
(86) PCT No.: PCT/JP2013/067976

§ 371 Date: Dec. 31, 2014

(30) Foreign Application Priority Data
Jul. 4, 2012 (JP) 2012-150918

(51) Int. Cl. H01G 11/70; H01G 11/72; H01G 11/68; H01G 11/06

(52) U.S. Cl. CPC H01G 11/70; H01G 11/06; H01G 11/72; H01G 11/68

(57) ABSTRACT

Provided is a lithium-ion capacitor having increased capacity, while also having suppression of the falling away of an active material from a current collector. The lithium-ion capacitor includes: a positive electrode and a negative electrode, both including the active material and the current collector holding the active material; and a non-aqueous electrolyte having lithium ion conductivity. At least one of the current collectors is a porous body having interconnected pores and a porosity of over 30% and 98% or less, the pores filled with either one of the active materials that can reversibly carry lithium. At least one of the active materials is pre-doped with lithium. The lithium pre-doped into the negative electrode active material is, in part or in whole, pre-doped from lithium electrochemically connected to the negative electrode, directly or after passing through at least one or more of the positive electrodes.

### TECHNICAL FIELD

The present invention relates to a lithium-ion capacitor.

### BACKGROUND ART

With close attention being given to environmental issues, development of a system for converting clean energy such as sunlight and wind power into electric power and then storing it as electric energy, is widely conducted. As electricity storage devices of this kind, lithium-ion secondary batteries (LIBs) and electric double-layer capacitors (EDLCs) are known. However, lithium-ion secondary batteries are limited in the ability to charge and discharge a great amount of electric power in a short time, whereas electric double-layer capacitors are limited in the amount of electricity that can be stored. Therefore, in recent years, lithium-ion capacitors (LICs) are gaining attention as high-capacity electricity storage devices having the advantages of both lithium-ion secondary batteries and electric double-layer capacitors.

Typically, LICs comprise: a positive electrode including a current collector of aluminum foil and a layer containing an activated carbon formed thereon; a negative electrode including a current collector of copper foil and a layer containing, for example, a carbon material capable of absorbing and releasing lithium ions formed thereon; and a non-aqueous electrolyte (Patent Literature 1). LICs have a high voltage of 2.5 to 4.2 V as with LIBs and are capable of charge and discharge at a high rate as with EDLCs.

For performance of LICs to be delivered sufficiently, at least one of the positive electrode active material and the negative electrode active material needs to be pre-doped with lithium. This is because when the positive electrode active material is an activated carbon and the negative electrode active material is a hard carbon for example, the positive electrode and the negative electrode do not initially contain lithium; and therefore, without any addition of lithium, ions for transferring charge would be insufficient. Moreover, to obtain high-voltage LICs, lithium is preferably pre-doped into the negative electrode in advance to lower the negative electrode potential.

Therefore, a lithium metal foil is disposed to face the positive electrode or the negative electrode, and after a short circuit occurs between the foil and the electrode via the non-aqueous electrolyte, lithium is electrochemically supplied to at least one of the positive electrode and the negative electrode.

In the field of organic electrolyte batteries also, a proposal has been made to pre-dope lithium into the positive electrode or the negative electrode to obtain high-capacity, high-voltage batteries that can be produced easily. Here, lithium is made to face the negative electrode and lithium is pre-doped into the negative electrode, directly or after passing through at least one or more of the positive electrodes (Patent Literature 2).

### PRIOR ART

### Patent Literature

[Patent Literature 1] Japanese Laid-Open Patent Publication No. 2001-143702
[Patent Literature 2] WO 2000/007255

### SUMMARY OF INVENTION

### Problem of Invention

As the foregoing, in a conventional LIC, metal foils such as aluminum foil and copper foil are used as current collectors for electrodes, and a layer containing an active material is formed on the respective surfaces of the foils. Therefore, if a layer containing the active material is formed thick, the active material would easily fall away from the current collectors. Although an anchoring effect can be achieved by etching or machining the metal foils, in view of ensuring the strengths of the metal foils, such processing has its limitations. For example, when processing the metal foils, processing can be conducted only up to a limited porosity of 30%. Therefore, there is a limit to the amount of the active material that can be held by the current collectors, making it difficult to obtain a high-capacity LIC.

### Solution to Problem

The present invention relates to a lithium-ion capacitor comprising: a positive electrode having a positive electrode active material and a positive electrode current collector holding the positive electrode active material; a negative electrode having a negative electrode active material and a negative electrode current collector holding the negative electrode active material; and a non-aqueous electrolyte having lithium ion conductivity, at least one selected from the positive electrode current collector and the negative electrode current collector being a porous body having interconnected pores, the porosity of the porous body being over 30% and 98% or less, the interconnected pores being filled with the positive electrode active material or the negative electrode active material, the positive electrode active material or the negative electrode active material being configured to reversibly carry lithium, at least one selected from the positive electrode active material and the negative electrode active material being pre-doped with lithium, and the lithium pre-doped into the negative electrode active material being, in whole or in part, pre-doped from lithium electrochemically connected to the negative electrode, directly or after passing through at least one or more of the positive electrodes. Here, “the lithium pre-doped into the negative electrode active material, in whole or in part” means “the whole or a part of the lithium when it is pre-doped into the negative electrode active material”. At least one selected from the positive electrode active material and the negative electrode active material is pre-doped with lithium, and preferably at least the negative electrode active material is pre-doped with lithium. In that case, the positive electrode active material may also be pre-doped with lithium. Due to pre-doping lithium into the negative electrode, voltage of the capacitor can be raised and the effect of improving both capacity and output can be expected; and due to pre-doping lithium into the positive electrode, the effect of enabling the positive electrode to have a high capacity by eliminating its irreversible capacity in advance, can be expected.

Since the current collector is a porous body having interconnected pores, the active material is introduced into the interconnected pores. Thus, regardless of the electrode thickness, the falling away of the active material from the current collector is suppressed, and occurrences of an internal short circuit (short circuit rate) can be reduced. Moreover, since almost every distance between the active material and the component materials of the current collector is limited to half, or less than half, of the maximum diameter of the interconnected pores, the electrode has low electrical resistance and high current collecting efficiency. Furthermore, since the porous body has a high porosity of over 30% and 98% or less, large amounts of the active material can be introduced into the interconnected pores and a high-capacity electrode can be obtained. Still furthermore, due to the high porosity, transfer of lithium ions is made easier during pre-doping of lithium, and the pre-doping progresses efficiently.

For the lithium-ion capacitor of the present invention, the ratio of a capacity Cn of the negative electrode to a capacity Cp of the positive electrode: Cn/Cp may be 1.2 to 10. Due to the ratio Cn/Cp being a desired value, a lithium-ion capacitor with a significantly high energy density can be obtained.

It will suffice if the porosity of the current collector, i.e., a porous body with interconnected pores, is over 30% and 98% or less. When the porosity is 80% to 98%, larger amounts of the active material can be introduced into the interconnected pores, and transfer of lithium ions is made much easier during pre-doping of lithium.

The current collector, i.e., a porous body with interconnected pores, preferably has a three-dimensional mesh-like structure. Due to the current collector having a three-dimensional mesh-like structure, the resultant electrode has a higher current collecting efficiency and the current collector has a higher ability to hold the active material.

In one aspect, the lithium-ion capacitor of the present invention has a porous body of aluminum or aluminum alloy (hereinafter also referred to as “Al porous body”) with a three-dimensional mesh-like structure as the positive electrode current collector, and a porous body of copper or copper alloy (hereinafter also referred to as “Cu porous body”) with a three-dimensional mesh-like structure as the negative electrode current collector. Due to selecting specific metals as above, the positive and negative electrodes both have much improved current collecting properties; and furthermore, the positive and negative electrodes both have higher capacities, the active materials are prevented from falling away from the electrodes, and the time required for pre-doping lithium can be made considerably shorter.

It is preferable to pre-dope lithium into the negative electrode active material, in an amount corresponding to 90% or less of the difference between the negative electrode capacity Cn and the positive electrode capacity Cp: Cn−Cp. Due to the above, the reversible capacity of the negative electrode is prevented from becoming lower than the positive electrode capacity, and the lithium-ion capacitor becomes regulated by the positive electrode, thereby making growth of lithium dendrites unlikely.

### Advantageous Effect of Invention

According to the present invention, there can be provided a lithium-ion capacitor (LIC) at least having increased capacity while also having suppression of the falling away of an active material from a current collector.

### BRIEF DESCRIPTION OF DRAWINGS

FIG. 1A is an illustration of an example of a production method of an Al porous body according to the present invention.

FIG. 1B is an illustration of the example of the production method of an Al porous body according to the present invention.

FIG. 1C is an illustration of the example of the production method of an Al porous body according to the present invention.

FIG. 2 is an illustration of the cell structure of the lithium-ion capacitor.

### DESCRIPTION OF EMBODIMENTS

A lithium-ion capacitor of the present invention comprises: a positive electrode having a positive electrode active material and a positive electrode current collector holding the positive electrode active material; a negative electrode having a negative electrode active material and a negative electrode current collector holding the negative electrode active material; and a non-aqueous electrolyte having lithium ion conductivity. At least one selected from the positive electrode current collector and the negative electrode current collector is a porous body having interconnected pores, and the porosity of the porous body is over 30% and 98% or less. The interconnected pores are filled with the positive electrode active material or the negative electrode active material. The positive electrode active material or the negative electrode active material is configured to reversibly carry lithium, and at least one selected from the positive electrode active material and the negative electrode active material is pre-doped with lithium. Here, the lithium pre-doped into the negative electrode active material is, in whole or in part, pre-doped from lithium electrochemically connected to the negative electrode, directly or after passing through at least one or more of the positive electrodes. Note that lithium may be lithium metal or lithium alloy such as lithium-aluminum alloy.

Here, carrying is a concept which includes adsorption and intercalation (absorption). For example, carrying of lithium by the active material means adsorption of lithium to the active material surface, or, intercalation (absorption) of lithium into the crystal structure of the active material. Moreover, to pre-dope means to have lithium absorbed in the active material in advance, before the cell is operated as the lithium-ion capacitor.

Lithium electrochemically connected to the negative electrode is disposed such that lithium ions that dissolve therefrom can reach the negative electrode. Such lithium is, for example, shorted with the negative electrode via the non-aqueous electrolyte and is usually placed in the lithium-ion capacitor, together with the non-aqueous electrolyte, the negative electrode, and the positive electrode.

Moreover, lithium pre-doped directly from the lithium electrochemically connected to the negative electrode, is pre-doped from the lithium that is disposed, for example, so as to face the negative electrode. Furthermore, lithium pre-doped after passing through at least one or more of the positive electrodes is, for example, pre-doped into the negative electrode that is disposed such that the positive electrode is placed in between the negative electrode and the lithium. For example, when the lithium is disposed so as to face the positive electrode and not to face the negative electrode, most of the lithium is pre-doped into the negative electrode after passing through at least one of the positive electrodes.

When the positive electrode current collector has interconnected pores, the interconnected pores are filled with the positive electrode active material. Moreover, when the negative electrode current collector has interconnected pores, the interconnected pores are filled with the negative electrode active material. The interconnected pores are portions surrounded by the component materials of the current collector. Due to such interconnected pores being filled with the active material, the falling away of the active material from the current collector is suppressed regardless of the electrode thickness. Moreover, almost every distance between the active material and the component materials of the current collector is limited to half, or less than half, of the maximum diameter of the interconnected pores. Thus, the electrode has low electrical resistance and high current collecting efficiency.

Due to the porous body having a high porosity of over 30% and 98% or less, large amounts of the active material can be introduced into the porous body. Thus, the resultant electrode can have a high capacity. Moreover, due to the high porosity, lithium ions can move easily through the positive or negative electrode during pre-doping of lithium. Thus, since pre-doping of lithium progresses efficiently, the time required for the pre-doping can be made shorter.

In view of achieving the foregoing effect to the maximum extent possible, it is preferable that both of the positive and negative electrode current collectors are porous bodies with interconnected pores, and further preferable that both of the current collectors have a porosity of over 30% and 98% or less.

Here, porosity is the value of the ratio of {1−(mass of porous body/true specific density of porous body)/(apparent volume of porous body)} expressed as percentage (%). The apparent volume of the porous body is the volume of the porous body with the voids included.

Lithium is pre-doped when the capacitor is assembled. The pre-doping is conducted under conditions where, for example, lithium metal is placed in the cell, together with the positive electrode, the negative electrode, and the non-aqueous electrolyte; and the lithium metal is shorted with the positive electrode and the negative electrode via the non-aqueous electrolyte. At that time, an insulating material may be interposed between the lithium metal and the positive and negative electrodes, or alternatively, electrical continuity may be produced between the lithium metal and the positive or negative electrode to cause a short circuit therebetween. When electrical continuity is produced between the lithium metal and the positive or negative electrode, voltage may be applied therebetween to forcibly pre-dope lithium into the positive or negative electrode.

In view of increasing capacity, the porosity of the porous body is preferably 80% to 98%, but the lower and upper limits of the porosity are not limited thereto. The lower limit of the porosity may be, for example, over 30%, or 40% or 50%. Moreover, the upper limit thereof may be less than 80%, or 79% or less. For example, even when the porosity is 35% to less than 80%, the resultant lithium-ion capacitor can have a sufficiently high capacity.

Note that in pre-doping lithium into at least one of the positive electrode active material and the negative electrode active material, metal foils such as aluminum foil and copper foil become barriers that inhibit transfer of lithium ions. Therefore, the time required for the pre-doping becomes longer, making it difficult to improve productivity of the LIC. In contrast, when the porosity is over 30%, since transfer of lithium ions is rarely inhibited, the time required for the pre-doping can be made shorter than that in the past.

A conventional LIC is designed such that the negative electrode capacity Cn is significantly higher than the positive electrode capacity Cp. One of the reasons is because in order to ensure the anion-adsorbing and anion-desorbing abilities of the positive electrode, it would be difficult to form a layer including the positive electrode active material that is thick. That is, the thicker the layer including the positive electrode active material becomes, the more difficult it becomes for the positive electrode active material on a surface layer portion of the positive electrode to adsorb and desorb (charge and discharge) anions, leading to a lower positive electrode utilization rate (amount of electric charge actually stored/theoretical value of storable electric charge calculated from amount of active material). Moreover, another reason for the above is because relatively large amounts of lithium need to be pre-doped into the negative electrode active material, in order to lower the negative electrode potential. Therefore, in a conventional LIC, the negative electrode capacity Cn is made approximately more than 10 times higher than the positive electrode capacity Cp.

In contrast, according to the present invention, the positive electrode capacity can be improved significantly, and almost every distance between the positive electrode active material and the component materials of the positive electrode current collector can also be limited to half, or less than half, of the maximum diameter of the interconnected pores. Moreover, due to the good current collecting property of the positive electrode, the positive electrode is suited to charge and discharge at a high rate, and the utilization rate of the positive electrode active material also improves. Therefore, the ratio of the negative electrode capacity Cn to the positive electrode capacity Cp: Cn/Cp can be 1.2 to 10.

Here, the positive electrode capacity Cp is the theoretical value of storable electric charge calculated from the amount of the positive electrode active material in the positive electrode. Moreover, the negative electrode capacity Cn is the theoretical value of the storable electric charge calculated from the amount of the negative electrode active material in the negative electrode. These theoretical values also include irreversible capacities.

The porous body having interconnected pores preferably has a three-dimensional mesh-like structure. Here, three-dimensional mesh-like structure refers to a structure in which strands of a rod-like or fiber-like material forming the current collector interconnect with one another in a three-dimensional manner to form a network.

An Al porous body having a three-dimensional mesh-like structure can be given as the positive electrode current collector that is preferable, and a Cu porous body having a three-dimensional mesh-like structure can be given as the negative electrode current collector that is preferable. Both of the matrix structures are three-dimensional mesh-like structures, and have therein interconnected pores that extend three-dimensionally. The Al porous body is excellent in current collecting performance, due to the presence of an Al skeletal structure therein that extends continuously and has high conductivity and excellent voltage withstanding ability. Moreover, the Cu porous body is also excellent in current collecting performance, due to the presence of a Cu skeletal structure therein that extends continuously and has excellent conductivity. Furthermore, the Cu porous body is more advantageous compared to a porous body of nickel or nickel alloy (hereinafter also referred to as “Ni porous body”) having a three-dimensional mesh-like structure, in that electron conductivity is high and contact resistance with the active material is small.

However, when lithium titanium oxide such as lithium titanate (LTO) is used as the negative electrode active material, the Al porous body can be used as the negative electrode current collector; and when a material containing silicon (Si) or tin is used as the negative electrode active material, the Ni porous body can also be used as the negative electrode current collector. Due to using the Al porous body as the negative electrode current collector, the LIC can be made lightweight.

In view of sufficiently lowering the negative electrode potential, the negative electrode active material is preferably pre-doped with a sufficient amount of lithium. However, when the reversible capacity of the negative electrode becomes lower than the positive electrode capacity, lithium dendrites may grow and an internal short circuit may possibly occur. Therefore, it is effective to pre-dope lithium into the negative electrode active material, in an amount corresponding to 90% or less, and preferably 80% to 90%, of the difference between the negative electrode capacity Cn and the positive electrode capacity Cp: Cn−Cp.

In the present invention, it will suffice if at least one of the positive electrode current collector and the negative electrode current collector is the porous body as above. Thus, if the positive electrode current collector is the porous body as above, the negative electrode current collector may be, for example, an expanded metal, a perforated screen, a perforated metal, or a lath; and if the negative electrode current collector is the porous body as above, the positive electrode current collector may be, for example, an expanded metal, a perforated screen, a perforated metal, or a lath.

However, materials such as an expanded metal, a perforated screen, a perforated metal, and a lath can be processed only up to a limited porosity of 30%, and practically have a two-dimensional structure. Thus, in view of sufficiently increasing the electrode capacity and considerably shortening the time required for pre-doping lithium while also preventing the active material from falling away, both of the positive and negative electrode current collectors are preferably porous bodies with interconnected pores and their porosities are preferably over 30% and 98% or less.

In the following, the present invention will be described in detail through descriptions of each of the components of the LIC, based on the premise that both of the positive and negative current collectors are porous bodies with interconnected pores.

LICs with the following structure have a significantly high capacity. Moreover, since both of the positive and negative electrode current collectors have a high porosity of over 30% and 98% or less, lithium ions and anions can move easily in the cell. Furthermore, in both of the positive and negative electrodes, the respective distances between the active material and the component materials of the current collector are restricted to a short distance. Thus, the LICs can be designed to have high capacity, excellent high output characteristics, and easy pre-doping of lithium.

[Positive Electrode]

The positive electrode includes the positive electrode active material and the positive electrode current collector holding the positive electrode active material. The positive electrode may also include a lead terminal. The lead terminal may be attached by welding.

The amount of the positive electrode active material introduced into the positive electrode current collector is not particularly limited and is, per the apparent area of the current collector, preferably 1 to 120 mg/cm² and further preferably 10 to 100 mg/cm² for example. Here, apparent area refers to the area of the current collector orthographically projected, seen in a direction perpendicular to its principle surface.

The positive electrode is obtained by introducing a slurry containing the positive electrode active material into the interconnected pores in the positive electrode current collector. The slurry may be introduced in a known manner such as press fitting. Alternatively, the slurry may be introduced in the manner of immersing the positive electrode current collector in the slurry and reducing the atmospheric pressure as necessary; or in the manner of spraying the slurry to the positive electrode current collector starting from one surface, while applying pressure to the slurry with a device such as a pump.

After being filled with the slurry, the positive electrode may be dried as necessary to remove a dispersion medium in the slurry. Furthermore, the positive electrode current collector filled with the active material may be pressed as necessary. For pressing, a roller press machine can be used.

Due to pressing, the positive electrode active material introduced can be made denser and the strength of the positive electrode can be increased. Moreover, the positive electrode can be adjusted to have a desired thickness. The thickness of the positive electrode before pressing is usually about 300 to 5000 μm and that after pressing is usually about 150 to 3000 μm.

[Positive Electrode Current Collector]

The positive electrode current collector is a porous body with interconnected pores and has a porosity of over 30% and 98% or less. The porous body preferably has a three-dimensional mesh-like structure. The material of the porous body is, for example, aluminum or aluminum alloy, the aluminum alloy including less than 50 mass % of an element other than Al.

The porous body of aluminum or aluminum alloy (Al porous body) with the three-dimensional mesh-like structure has a weight per unit area of 80 to 1000 g/m². The porosity may be over 30% and less than 80%, but 80% to 98% is preferable. Note that when the porosity is over 30% and less than 80%, and furthermore, 35% to 75%, it is easier to ensure high strength for the positive electrode current collector; and when the porosity is 80% to 98%, and furthermore, 85% to 98%, it is easier to ensure high capacity for the positive electrode. For a commercially available Al porous body, “Aluminum-Celmet®” available from Sumitomo Electric Industries, Ltd. can be used.

The Al porous body is excellent in current collecting performance due to the presence of an Al skeletal structure therein that extends continuously and has high conductivity and excellent voltage withstanding ability. Moreover, since the active material is included in the interconnected pores throughout the Al porous body, the respective contents of a binder and/or an auxiliary conductive agent can be reduced. Thus, the filling density of the active material can be made higher. As a result, internal resistance can be lowered and capacity can be increased.

The average thickness of the positive electrode current collector is about 150 to 6000 μm and preferably about 200 to 3000 μm. Here, average thickness is the average of values obtained by measuring the thickness at ten arbitrarily-selected areas of 10 cm².

The Al porous body can be obtained by forming an Al coating layer on a surface of a resin foam or non-woven fabric serving as a base material and then removing the base material. The resin foam is not particularly limited as long as it is a porous resin body. For example, a urethane foam (polyurethane foam) or a styrene foam (polystyrene foam) can be used. A urethane foam is particularly preferable for its high porosity, highly uniform cell diameters, and excellent thermal decomposition property. When a urethane foam is used, the thickness is not likely to vary, and the resultant Al porous body has a surface with a high degree of flatness.

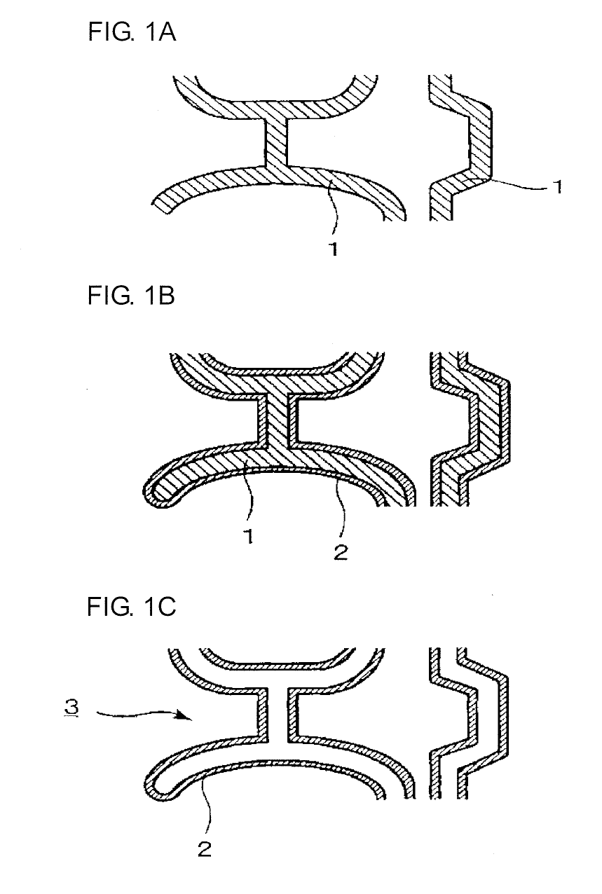

FIGS. 1A to 1C are schematic illustrations depicting an example of a production method of an Al porous body.

FIG. 1A is a schematic enlarged partial sectional view of a resin foam with interconnected pores, depicting the interconnected pores (voids) formed between portions of the skeletal structure of a resin foam 1 having a three-dimensional mesh-like structure.

First, the resin foam 1 with the interconnected pores is prepared, and an Al layer 2 is formed on a surface of the foam. Thus, an Al-coated resin foam as in FIG. 1B is obtained.

The porosity of the resin foam 1 may be, for example, over 30% up to 98%. Moreover, the cell diameter (interconnected pore diameter) of the resin foam 1 is preferably 50 to 1000 μm. Here, interconnected pore diameter refers to the diameter of a sphere which encompasses a regular dodecahedron, when an unclosed portion surrounded by the wall surface of the resin foam 1 is approximated to a regular dodecahedron.

Examples of a method to form the Al layer 2 on the surface of the resin foam 1 include gas phase methods such as vapor deposition, sputtering, and plasma CVD and molten salt electroplating. Particularly preferred among these is molten salt electroplating. In the method to form the Al layer 2 on the surface of the resin foam 1 by molten salt electroplating, the resin foam 1 undergoes, for example, a process of (i) treatment to impart conductivity thereto, followed by (ii) electroplating; and thereafter, the resultant undergoes (iii) heat treatment (removal of the resin foam 1), followed by (iv) reduction treatment as necessary. Thus, an Al porous body can be obtained.

For treatment to impart conductivity, a conductive material such as an Al coating is attached to the surface of the resin foam 1 by vapor deposition or sputtering. Alternatively, a conductive coating material containing carbon or the like may be applied to the surface of the resin foam 1. Then, the resin foam 1 rendered conductive is immersed in a molten salt, and an electric potential is applied to the Al coating or conductive coating material that has been attached in advance, thereby to conduct electroplating. At that time, plating is conducted using aluminum as an anode and the resin foam 1 rendered conductive as a cathode.

The molten salt plating bath may be of an organic molten salt, i.e., a eutectic salt comprising an organic halide and an aluminum halide (e.g., AlCl₃), or of an inorganic molten salt, i.e., a eutectic salt comprising a halide of alkaline metal and an aluminum halide. The organic halide can be, for example, an imidazolium salt or a pyridinium salt. Specifically, 1-ethyl-3-methylimidazolium chloride (EMIC) or butylpyridinium chloride (BPC) is preferable. The halide of alkaline metal can be, for example, lithium chloride (LiCl), potassium chloride (KCl), or sodium chloride (NaCl). Since the molten salt would deteriorate if moisture and/or oxygen get mixed therein, plating is preferably conducted in an atmosphere of inactive gas such as nitrogen or argon within a closed environment.

Preferred among the foregoing is the molten salt plating bath containing nitrogen, particularly the imidazolium salt bath. The imidazolium salt bath is preferred since plating is possible at a relatively low temperature. Preferable as the imidazolium salt is a salt including imidazolium cations having an alkyl group at the 1- and 3-positions. Utmost preferable is a molten salt based on aluminum chloride and 1-ethyl-3-methylimidazolium chloride (AlCl₃+EMIC) in particular, due to being highly stable and difficult to decompose. The temperature of the molten salt plating bath is 10° C. to 60° C. and preferably 25° C. to 45° C. The range of current density at which plating is possible becomes narrower as the temperature becomes lower, and this makes plating difficult.

Thereafter, heating is conducted at a temperature equal to or higher than the decomposition temperature of the resin foam 1 and equal to or lower than the melting point of Al (660° C.), and preferably at 500 to 650° C. This causes the resin foam 1 to decompose and only the Al layer 2 to remain as in FIG. 1C to form an Al porous body 3 reflecting the cell diameter and porosity of the resin foam 1. By pressing the Al porous body 3 thereafter, the porosity of the Al porous body 3 can be adjusted as appropriate.

[Positive Electrode Active Material]

The positive electrode active material can be of a material capable of reversibly carrying lithium and electrochemically adsorbing anions, examples including activated carbon and carbon nanotubes. Among these, activated carbon is preferred; and for example, over 50 mass % of the positive electrode active material is preferably activated carbon.

Regarding the activated carbon, a common commercially available one for electric double-layer capacitors can be used likewise for the lithium-ion capacitor. Examples of raw material for the activated carbon include wood, coconut shell, pulp wastewater, charcoal, heavy oil, charcoal-based pitch and oil-based pitch obtained by thermally decomposing charcoal and heavy oil, and phenolic resin.

A material that has undergone carbonization is usually activated thereafter. Examples of activation include gas activation and chemical activation. Gas activation is a process in which a carbonized material is catalytically reacted with, for example, water vapor, carbon dioxide, or oxygen at a high temperature, thereby to obtain activated carbon. Chemical activation is a process in which the foregoing raw material is impregnated with a known chemical for activation and then heated in an inactive gas atmosphere, to cause dehydration of the chemical and an oxidation reaction, thereby to obtain activated carbon. Examples of the chemical for activation include zinc chloride and sodium hydroxide.

The average particle size (median diameter for volume-based particle size distribution; the same hereinafter) of the activated carbon is not particularly limited and is preferably 20 μm or less. The specific surface area is also not particularly limited and is preferably about 800 to 3000 m²/g. Due to the average particle size and the specific surface area being in the above ranges, higher electrostatic capacity and lower internal resistance can be obtained in the LIC.

The positive electrode active material is introduced into the interconnected pores in the positive electrode current collector in the form of a slurry. The slurry may contain a binder and/or an auxiliary conductive agent in addition to the positive electrode active material.

The kind of the binder is not particularly limited, and any known or commercially available material can be used. Examples include polyvinylidene fluoride, polytetrafluoroethylene, polyvinylpyrrolidone, polyvinyl chloride, polyolefin, styrene-butadiene rubber, polyvinyl alcohol, and carboxymethyl cellulose. The binder amount is not particularly limited and is, for example, 0.5 to 10 parts by mass per 100 parts by mass of the positive electrode active material. Due to the binder amount being in the above range, the strength of the positive electrode can be improved, while increase in electrical resistance and reduction in electrostatic capacity are suppressed.

The kind of the auxiliary conductive agent is also not particularly limited, and any known or commercially available material can be used. Examples include acetylene black, Ketjenblack, carbon fibers, natural graphite (e.g., flake graphite, amorphous graphite), artificial graphite, and ruthenium oxide. Preferred among these are, for example, acetylene black, Ketjenblack, and carbon fibers. Use of the above can improve conductivity in the LIC. The auxiliary conductive agent amount is not particularly limited and is, for example, 0.1 to 10 parts by mass per 100 parts by mass of the positive electrode active material.

The slurry is obtained, for example, by stirring the positive electrode active material together with a dispersion medium, using a mixer. The proportions of these components in the slurry are not particularly limited. The dispersion medium is, for example, N-methyl-2-pyrrolidone (NMP) or water. When the binder is, for example, polyvinylidene fluoride, the dispersion medium may be NMP; and when the binder is, for example, polytetrafluoroethylene, polyvinyl alcohol, or carboxymethyl cellulose, the dispersion medium may be water. A surfactant may be used as necessary.

[Negative Electrode]

The negative electrode includes the negative electrode active material and the negative electrode current collector holding the negative electrode active material. The negative electrode may include a lead terminal. The lead terminal may be attached by welding.

The amount of the negative electrode active material introduced into the negative electrode current collector is not particularly limited and is, per the apparent area of the current collector, preferably 1 to 400 mg/cm² and further preferably 10 to 150 mg/cm² for example.

The negative electrode is obtained by introducing a slurry containing the negative electrode active material, into the interconnected pores in the negative electrode current collector. The slurry can be introduced in a manner similar to that for the positive electrode.

After being filled with the slurry, the negative electrode may be dried as necessary to remove a dispersion medium included in the slurry. Furthermore, the negative electrode current collector filled with the active material may be pressed as necessary. For pressing, a roller press machine can be used.

Due to pressing, the negative electrode active material introduced can be made denser and the strength of the negative electrode can be increased. Moreover, the negative electrode can be adjusted to have a desired thickness. The thickness of the negative electrode before pressing is usually about 50 to 3000 μm and that after pressing is usually about 30 to 1500 μm.

[Negative Electrode Current Collector]

The negative electrode current collector is a porous body with interconnected pores and has a porosity of over 30% and 98% or less. The porous body preferably has a three-dimensional mesh-like structure. The material of the porous body is, for example, copper, copper alloy, nickel, nickel alloy, or stainless steel, or aluminum or aluminum alloy capable of use as the positive electrode current collector. The copper alloy includes less than 50 mass % of an element other than copper, and the nickel alloy includes less than 50 mass % of an element other than nickel.

The porous body of copper or copper alloy (Cu porous body) with the three-dimensional mesh-like structure has a weight per unit area of 80 to 1000 g/m². The porosity may be over 30% and less than 80%, but 80% to 98% is preferable. Note that when the porosity is over 30% and less than 80%, and furthermore, 35% to 75%, it is easier to ensure high strength for the negative electrode current collector; and when the porosity is 80% to 98%, and furthermore, 85% to 98%, it is easier to ensure high capacity for the negative electrode.

The Cu porous body is excellent in current collecting performance, due to the presence of a Cu skeletal structure therein that extends continuously and has excellent conductivity. Moreover, since the active material is included in the interconnected pores throughout the Cu porous body, the respective contents of a binder and/or an auxiliary conductive agent can be reduced. Thus, the filling density of the active material can be made higher. As a result, internal resistance can be lowered and capacity can be increased.

The average thickness of the negative electrode current collector is about 50 to 3000 μm and preferably about 100 to 1500 μm.

The Cu porous body can be obtained by forming a Cu coating layer on a surface of a resin foam or non-woven fabric serving as a base material and then removing the base material. Here also, the resin foam is preferably a urethane foam. As with the Al coating layer, gas phase methods such as vapor deposition, sputtering, and plasma CVD and electroplating can be used for the Cu coating layer. Among these, electroplating is preferred.

Electroplating is conducted by using, for example, a known bath such as a copper sulfate plating bath. The resin foam 1 rendered conductive is immersed in the plating solution, and an electric potential is applied to the Cu coating or a conductive coating material that has been attached to the resin foam 1 in advance, thereby to conduct electroplating.

Thereafter, heating is conducted at a temperature equal to or higher than the decomposition temperature of the resin foam and equal to or lower than the melting point of Cu (1085° C.), and preferably at 600 to 1000° C. This causes the resin foam to decompose and only the Cu layer to remain to form a Cu porous body.

Thereafter, the Cu porous body is baked in a reducing atmosphere (e.g., hydrogen gas containing atmosphere) to remove an oxide film from its surface. Note that although a porous body of nickel or nickel alloy (Ni porous body) with a matrix structure can be produced in a similar manner, the Cu porous body has a better surface condition after reduction and has a smaller contact resistance with the negative electrode active material, compared to the Ni porous body.

[Negative Electrode Active Material]

The negative electrode active material may be a material capable of reversibly carrying lithium, e.g., a material capable of electrochemically absorbing and releasing lithium ions; and in view of ensuring the difference between the negative electrode capacity and the positive electrode capacity that is sufficient and making the LIC have a high voltage, the material preferably has a theoretical capacity of 300 mAh/g or higher. Examples of the negative electrode active material include carbon materials such as graphite, hard carbon (non-graphitizable carbon), and soft carbon (graphitizable carbon), lithium titanium oxide (e.g., lithium titanate), silicon, silicon oxide, silicon alloy, tin, tin oxide, and tin alloy. Among these, graphite and hard carbon are preferred, and for example, over 50 mass % of the negative electrode active material is preferably at least one of graphite and hard carbon.

Note that when a carbon material is used, the Cu porous body is preferably used as the negative electrode current collector; when silicon, silicon oxide, silicon alloy, tin, tin oxide, or tin alloy is used, the Ni porous body is preferably used as the negative electrode current collector; and when lithium titanate is used, the Al porous body is preferably used as the negative electrode current collector.

The average particle size (median diameter for volume-based particle size distribution) of the negative electrode active material is not particularly limited and is preferably 20 μm or less.

The negative electrode active material is introduced into the interconnected pores in the negative electrode current collector in the form of a slurry, as with the positive electrode active material. The slurry may contain the binder and/or the auxiliary conductive agent in addition to the negative electrode active material. As the binder and the auxiliary conductive agent, materials usable in the positive electrode can be used without particular limitation.

[Pre-Doping of Lithium]

Lithium may be pre-doped into either the positive electrode active material or the negative electrode active material, but when the negative electrode active material is of a material not including lithium in advance, lithium is preferably pre-doped into at least the negative electrode active material. Due to pre-doping lithium into the negative electrode active material, the negative electrode potential lowers and the voltage of the capacitor becomes higher. Thus, such pre-doping is advantageous in making the capacity of LICs higher.

Lithium is pre-doped when the capacitor is assembled. For example, lithium metal foil is placed in a cell together with the positive electrode, the negative electrode, and the non-aqueous electrolyte; and then the assembled capacitor is kept warm in a constant temperature chamber at a temperature of about 60° C., thereby to cause lithium ions to dissolve from the lithium metal foil and be absorbed in the negative electrode active material. At that time, due to the positive and negative electrode current collectors both having a porosity of over 30% and 98% or less, lithium ions pass through the positive and negative electrodes and can move smoothly. Therefore, regardless of where the lithium metal foil is placed in the capacitor, pre-doping of lithium progresses rapidly. Moreover, by disposing the lithium metal foil to face the negative electrode, pre-doping of lithium can progress more rapidly.

The lithium metal foil may be attached to a surface of the positive or negative electrode. Alternatively, an insulating material (e.g., separator) may be interposed between the negative electrode and the lithium metal foil. In that case, the lithium metal foil may be held by a metal support, and both the foil and the support may be placed in the capacitor. Moreover, the metal support and the negative electrode in the cell may have an electrical continuity (short circuit) therebetween in advance. As the metal support, metal mesh, metal foil (e.g., copper foil), or the like that does not alloy with lithium can be used.

Since the positive electrode including the Al porous body as the positive electrode current collector has a high capacity and a good current collecting property, the utilization rate of the positive electrode active material improves. Therefore, compared to a conventional lithium-ion capacitor, it is easier to increase the positive electrode capacity Cp, and it is possible to make the ratio of the negative electrode capacity Cn to the positive electrode capacity Cp: Cn/Cp, smaller. For example, it is possible for the ratio Cn/Cp to be 1.2 to 10, and furthermore, 1.3 to 7. Thus, the lithium-ion capacitor can be designed to have an energy density that is significantly higher than in the past.

Moreover, by combining the positive electrode including the Al porous body as the positive electrode current collector and the negative electrode including the Cu porous body as the negative electrode current collector, capacity can be further increased. Furthermore, since the Al porous body and the Cu porous body both have a high porosity of over 30% and 98% or less, lithium ions and anions can move easily in the cell. Thus, even during charge and discharge at a high rate, the high utilization rate of the positive electrode active material can be maintained.

It is preferable that the amount of lithium pre-doped into the negative electrode active material is such that preferably 5 to 90% and further preferably 10 to 75% of the negative electrode capacity (Cn) becomes filled with the lithium. This enables the negative electrode potential to become sufficiently low, making it easier to obtain a high-voltage capacitor. However, if the amount of lithium pre-doped into the negative electrode active material is too large, the positive electrode capacity Cp would become larger than the reversible capacity of the negative electrode, and this may cause lithium dendrites. Prevention of such lithium dendrites is made easier by pre-doping lithium in an amount corresponding to 90% or less and preferably 80 to 90% of the difference between the negative electrode capacity Cn and the positive electrode capacity Cp: Cn−Cp.

[Non-Aqueous Electrolyte]

The non-aqueous electrolyte with lithium ion conductivity is preferably a non-aqueous solvent with a lithium salt dissolved therein. The concentration of the lithium salt in the non-aqueous electrolyte may be, for example, 0.3 to 3 mol/liter.

The lithium salt is not particularly limited, and is, for example, preferably LiClO₄, LiBF₄, or LiPF₆. These may be used singly or in a combination of two or more.

The non-aqueous solvent is not particularly limited and can be, for example, ethylene carbonate, propylene carbonate, butylene carbonate, dimethyl carbonate, diethyl carbonate, or ethyl methyl carbonate, in view of ion conductivity. These may be used singly or in a combination of two or more.

[Separator]

The separator, being capable of physically separating the positive and negative electrodes to prevent a short circuit therebetween and having lithium ion permeability, can be interposed between the positive and negative electrodes. The separator has a porous structure, and is able to pass lithium ions through the non-aqueous electrolyte in its pores. Examples of the separator material include polyolefin, polyethylene terephthalate, polyamide, polyimide, cellulose, and glass fibers. The average pore size of the separator is not particularly limited and is, for example, about 0.01 to 5 μm, and the thickness thereof is, for example, about 10 to 100 μm.

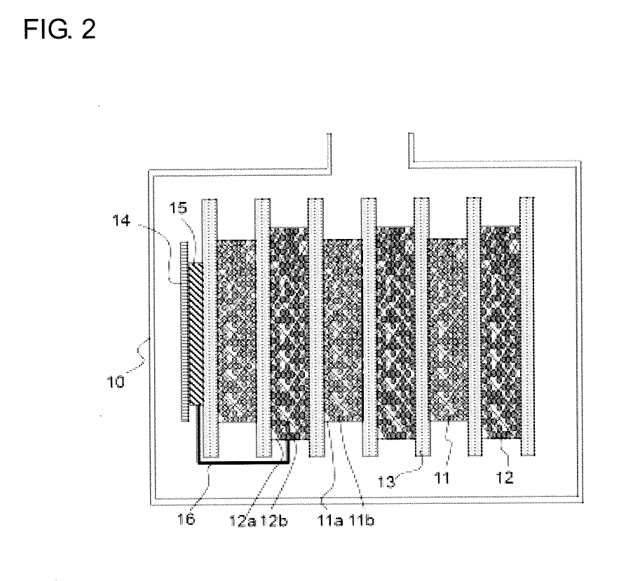

FIG. 2 schematically illustrates the cell structure of the lithium-ion capacitor. An electrode assembly and a non-aqueous electrolyte are housed in a cell case 10. The electrode assembly comprises a plurality of positive electrodes 11 and negative electrodes 12 that are stacked with a separator 13 interposed between the positive and negative electrodes. The positive electrode 11 includes: a positive electrode current collector 11a having a three-dimensional mesh-like structure; and a positive electrode active material 11b in particle form with which interconnected pores in the positive electrode current collector 11a are filled. The negative electrode 12 includes: a negative electrode current collector 12a having a three-dimensional mesh-like structure; and a negative electrode active material 12b in particle form with which interconnected pores in the negative electrode current collector 12a are filled. However, the electrode assembly is not limited to a stacked type, and can also be formed by spirally winding the positive electrode 11 and the negative electrode 12 with the separator 13 interposed therebetween. On the outer side of the negative electrode 12 positioned at the end of the electrode assembly, a lithium metal 15 attached to a metal support 14 is disposed via the separator 13. The metal support 14 is connected to the negative electrode 12 via a lead wire 16 to have the same potential as the negative electrode 12. Under these conditions, the lithium metal 15 dissolves into the non-aqueous electrolyte and moves toward the positive electrode 11 in the cell. At that time, lithium ions move smoothly in the cell because they can pass through the positive and negative current collectors which are porous bodies; and the lithium ions are progressively pre-doped due to their absorption into the negative electrode active material in each of the negative electrodes 12.

In the following, the present invention will be described in detail by way of Examples. However, note that the following Examples do not limit the present invention.

### Example 1

### [1] Production of Positive Electrode

### (1) Production of al Porous Body (Positive Electrode Current Collector)

Molten salt electroplating was conducted as follows, thereby to produce an Al porous body with a cell diameter of 550 μm, a weight per unit area of 140 g/m², and a thickness of 1000 μm.

Specific conditions were as follows.

(a) Base Material

A urethane foam with a thickness of 1000 mm, a porosity of 96%, and a cell diameter of 550 μm was used.

(b) Treatment to Impart Conductivity

An Al coating with a weight per unit area of 5 g/m² was formed on a surface of the urethane foam by sputtering.

(c) Composition of Molten Salt Plating Bath

AlCl₃ (aluminum chloride):EMIC (1-Ethyl-3-methylimidazolium chloride)=2:1 (molar ratio) was used.

(d) Pretreatment

Before plating, the base material serving as an anode was subjected to electrolytic treatment (at 2 A/dm² for 1 minute) for activation.

(e) Plating Conditions

The urethane foam with the Al coating formed on its surface, serving as a workpiece, was set to a jig having a power feeding function. Thereafter, the resultant was put into a glove box with an argon atmosphere at a dew point of −30° C. or lower, and immersed in the molten salt plating bath at 40° C. The jig with the workpiece set thereto was then connected to the cathode side of a rectifier, and an Al plate (99.99% purity) to serve as a counter electrode was connected to the anode side of the rectifier. Then, electroplating was conducted at a current of 2 A/dm². As a result, an Al layer was formed on the surface of the urethane foam.

(1) Heat Treatment

The urethane foam with the Al layer formed thereon was immersed in a molten LiCl—KCl eutectic salt at 500° C., and a negative potential of −1 V was applied for 5 minutes. This caused formation of air bubbles in the molten salt due to a decomposition reaction in the urethane. Thereafter, the resultant was cooled in the air until reaching room temperature and then washed with water to remove the molten salt, thereby to obtain an Al porous body free of resin.

### (2) Production of Positive Electrode

To 100 parts by mass of activated carbon powder (specific surface area: 2500 m²/g, average particle size: about 5 μm), 2 parts by mass of Ketjenblack (KB) serving as an auxiliary conductive agent, 4 parts by mass of polyvinylidene fluoride powder serving as a binder, and 15 parts by mass of N-methyl-2-pyrrolidone (NMP) serving as a dispersion medium were added. The resultant was then stirred with a mixer, thereby to prepare a positive electrode slurry containing activated carbon.

The Al porous body produced above with a weight per unit area of 140 g/m² and a thickness of 1000 μm was pressed with a roller press, thereby to obtain a positive electrode current collector with a thickness of 200 μm. The positive electrode slurry was introduced into the positive electrode current collector obtained, and then dried. Thereafter, the resultant was pressed with a roller press, thereby to obtain a positive electrode with a thickness of 75 μm. The porosity of the positive electrode current collector after pressing was 31%.

### [2] Production of Negative Electrode

### (1) Production of Cu Porous Body (Negative Electrode Current Collector)

Molten salt electroplating was conducted as follows, thereby to produce a Cu porous body with a cell diameter of 550 μm, a weight per unit area of 200 g/m², and a thickness of 1000 μm.

Specific conditions were as follows.

(a) Base Material

A urethane foam with a thickness of 1 mm, a porosity of 96%, and a cell diameter of 550 μm was used.

(b) Treatment to Impart Conductivity

A Cu coating with a weight per unit area of 5 g/m² was formed on a surface of the urethane foam by sputtering.

(c) Composition of Electroplating Bath

A copper sulfate plating bath of the following composition was used.

Copper sulfate: 250 g/L

Sulfuric acid: 50 g/L

Copper chloride: 30 g/L

Temperature: 30° C.

Cathodic current density: 2 A/dm²

(d) Plating Conditions

The urethane foam with the Cu coating formed on its surface, serving as a workpiece, was set to a jig having a power feeding function. Thereafter, the resultant was immersed in the copper sulfate plating bath at 30° C. The jig with the workpiece set thereto was then connected to the cathode side of a rectifier, and a Cu plate (99.99% purity) to serve as a counter electrode was connected to the anode side of the rectifier. Then, electroplating was conducted at a current of 2 A/dm². As a result, a Cu layer was formed on the surface of the urethane foam.

(e) Heat Treatment

The urethane foam with the Cu layer formed thereon was heat treated in a furnace with atmospheric air at 700° C., thereby to obtain a Cu porous body free of resin.

(f) Reduction Treatment

The Cu porous body was baked in a hydrogen atmosphere at 900° C. to remove an oxide film from the Cu surface.

### (2) Production of Negative Electrode

To 100 parts by mass of hard carbon powder (average particle size: about 10 μm), 3 parts by mass of acetylene black serving as an auxiliary conductive agent, 5 parts by mass of polyvinylidene fluoride serving as a binder, and 15 parts by mass of NMP serving as a dispersion medium were added. The resultant was then stirred with a mixer, thereby to prepare a negative electrode slurry containing hard carbon.

The Cu porous body produced above with a weight per unit area of 200 g/m² and a thickness of 1000 μm was pressed with a roller press, thereby to obtain a negative electrode current collector with a thickness of 100 μm. The negative electrode slurry was introduced into the negative electrode current collector obtained, and then dried. Thereafter, the resultant was pressed with a roller press, thereby to obtain a negative electrode with a thickness of 33 μm. The porosity of the negative electrode current collector after pressing was 31%.

### (3) Preparation of Non-Aqueous Electrolyte

One mol/L of LiPF₆ was dissolved in a mixed solvent comprising ethylene carbonate (EC) and diethyl carbonate (DEC) in a 1:1 volume ratio, thereby to prepare a non-aqueous electrolyte.

### (4) Production of Cell

The positive and negative electrodes obtained were each cut to a size of 3 cm×2.5 cm. A tab-lead of aluminum was welded to the positive electrode, whereas a tab-lead of nickel was welded to the negative electrode. These were transferred to a dry room, and first, were dried under reduced pressure at 140° C. for 12 hours.

Then, the positive and negative electrodes were stacked with a separator of cellulose interposed therebetween, thereby to form an electrode assembly, i.e., a unit cell. The unit cell was placed in a cell case made of an aluminum laminate sheet. The ratio of a capacity Cn of the negative electrode to a capacity Cp of the positive electrode: Cn/Cp was 3.2.

Then, a lithium metal foil (hereinafter, lithium electrode) compression bonded to a nickel mesh was surrounded by a separator of polypropylene (PP), and was disposed on the negative electrode side in the cell case so as not to come in contact with the unit cell.

Then, a non-aqueous electrolyte was injected into the cell case, causing both of the electrodes and the separator to be impregnated with the non-aqueous electrolyte.

Lastly, with a vacuum sealer, the cell case was sealed as pressure was reduced, thereby to complete a lithium-ion capacitor (LIC) of Example 1.

### (5) Pre-Doping of Li

The negative electrode and the lithium electrode were connected with a lead wire outside the cell. Then, lithium was pre-doped, with the current and time controlled such that the amount of the lithium pre-doped corresponded to 90% of the difference between the negative electrode capacity Cn and the positive electrode capacity Cp.

### Example 2

A LIC was produced as in Example 1, except in producing the positive electrode, the positive electrode current collector with a thickness of 200 μm, filled with the positive electrode slurry and dried, was pressed to obtain a positive electrode with a thickness of 94 μm. The porosity of the positive electrode current collector after pressing was 45% and the Cn/Cp ratio was 2.6.

### Example 3

A LIC was produced as in Example 1, except in producing the negative electrode, the negative electrode current collector with a thickness of 100 μm, filled with the negative electrode slurry and dried, was pressed to obtain a negative electrode with a thickness of 38 μm. The porosity of the negative electrode current collector after pressing was 42% and the Cn/Cp ratio was 3.8.

### Example 4

In producing the positive electrode, the positive electrode current collector with a thickness of 800 μm was filled with the positive electrode slurry and dried, and then pressed to obtain a positive electrode with a thickness of 430 μm. The porosity of the positive electrode current collector after pressing was 88%.

In producing the negative electrode, the negative electrode current collector with a thickness of 150 μm was filled with the negative electrode slurry and dried, and then pressed to obtain a negative electrode with a thickness of 75 μm. The porosity of the negative electrode current collector after pressing was 70%.

Other than the above, a LIC was produced as in Example 1. The Cn/Cp ratio was 1.3.

### Example 5

In producing the positive electrode, the positive electrode current collector with a thickness of 500 μm was filled with the positive electrode slurry and dried, and then pressed to obtain a positive electrode with a thickness of 260 μm. The porosity of the positive electrode current collector after pressing was 80%.

In producing the negative electrode, the negative electrode current collector with a thickness of 400 μm was filled with the negative electrode slurry and dried, and then pressed to obtain a negative electrode with a thickness of 190 μm. The porosity of the negative electrode current collector after pressing was 88%.

Other than the above, a LIC was produced as in Example 1. The Cn/Cp ratio was 5.3.

### Example 6

In producing the positive electrode, a positive electrode current collector was produced, with the only difference from the positive electrode current collector in Example 1 being the thickness (5000 μm); the positive electrode current collector with its thickness kept at 5000 μm was filled with the positive electrode slurry, followed by drying; and then the resultant was pressed, thereby to obtain a positive electrode with a thickness of 2600 μm. The porosity of the positive electrode current collector after pressing was 98%.

In producing the negative electrode, a negative electrode current collector was produced, with the only difference from the negative electrode current collector in Example 1 being the thickness (2000 μm); the negative electrode current collector with its thickness kept at 2000 μm was filled with the negative electrode slurry, followed by drying; and then the resultant was pressed, thereby to obtain a negative electrode with a thickness of 1100 μm. The porosity of the negative electrode current collector after pressing was 98%.

Other than the above, a LIC was produced as in Example 1. The Cn/Cp ratio was 3.2.

### Comparative Example 1

### (1) Production of Positive Electrode

Aluminum expanded metal (porosity: 25%) was used as a positive electrode current collector. The same positive electrode slurry as the one in Example 1 was applied to one surface of the positive electrode current collector. Thereafter, the resultant was dried and then pressed with a roller press, thereby to obtain a positive electrode with a thickness of 80 μm.

Copper expanded metal (porosity: 25%) was used as a negative electrode current collector. The same negative electrode slurry as the one in Example 1 was applied to one surface of the negative electrode current collector. Thereafter, the resultant was dried and then pressed with a roller press, thereby to obtain a negative electrode with a thickness of 80 μm.

Other than the above, a LIC was produced as in Example 1. The Cn/Cp ratio was 11.

### Comparative Example 2

### (1) Production of Positive Electrode

Aluminum perforated metal (porosity: 7%) was used as a positive electrode current collector. The same positive electrode slurry as the one in Example 1 was applied to one surface of the positive electrode current collector. Thereafter, the resultant was dried and then pressed with a roller press, thereby to obtain a positive electrode with a thickness of 40 μm.

Copper perforated metal (porosity: 7%) was used as a negative electrode current collector. The same negative electrode slurry as the one in Example 1 was applied to one surface of the negative electrode current collector. Thereafter, the resultant was dried and then pressed with a roller press, thereby to obtain a negative electrode with a thickness of 45 μm.

Other than the above, a LIC was produced as in Example 1. The Cn/Cp ratio was 13.

Ten LICs were produced for Examples 1 to 6 and Comparative Examples 1 and 2, respectively, and the presence or absence of an internal short circuit was checked by measuring their voltages. As a result, an internal short circuit was not observed in any of the LICs. From this, it can be understood that when the Al porous body and the Cu porous body are used, the active material is unlikely to fall away even if the electrode is very thick.

On the other hand, the time required for pre-doping lithium was less than 48 hours in Examples 1 to 6, but was 60 hours or more in Comparative Examples 1 and 2.

Table 1 shows the ratio between the positive electrode current collector porosity (%) and the negative electrode current collector porosity (%) (positive electrode/negative electrode), the Cn/Cp ratio, and the cell capacity (mAh) for the LICs of Examples 1 to 6 and Comparative Examples 1 and 2. Note that the cell capacity corresponds to the average of the capacities of 10 cells. Also, in Remarks, general descriptions of the current collectors used for the positive and negative electrodes are given. Here, “Al/Cu porous bodies” indicate that the Al porous body was used for the positive electrode and the Cu porous body was used for the negative electrode.

Moreover, regarding the respective materials of the expanded metals and the perforated metals, Al is used for the positive electrode current collector and Cu is used for the negative electrode current collector.

TABLE 1

| | Ratio between | | | |
|---|---|---|---|---|
| | porosities (%) | | Cell | |
| | (positive electrode/ | Cn/Cp | capacity | |
| | negative electrode) | ratio | (mAh) | Remarks |
| Ex. 1 | 31/31 | 3.2 | 2.4 | Al/Cu porous bodies |
| Ex. 2 | 45/31 | 2.6 | 3.2 | Al/Cu porous bodies |
| Ex. 3 | 31/42 | 3.8 | 2.4 | Al/Cu porous bodies |
| Ex. 4 | 88/70 | 1.3 | 10 | Al/Cu porous bodies |
| Ex. 5 | 80/88 | 5.3 | 6.3 | Al/Cu porous bodies |
| Ex. 6 | 98/98 | 3.2 | 42 | Al/Cu porous bodies |
| Comp. | 25/25 | 11 | 1.2 | Expanded metals |
| Ex. 1 | | | | |
| Comp. | 7/7 | 13 | 0.6 | Perforated metals |
| Ex. 2 | | | | |

From Table 1, it can be understood that the LICs of Examples 1 to 6 exhibit significantly increased capacities compared to Comparative Examples 1 and 2. Moreover, from the fact that the Cn/Cp ratios of these LICs are small, it also can be understood that their energy densities are high. Furthermore, in the LICs of Examples 1 to 6, regardless of the thicknesses of the positive and negative electrodes, occurrences of an internal short circuit were not observed. Thus, it can be understood that according to the present invention, a LIC with a significantly high capacity can be obtained, while occurrences of a short circuit are suppressed.

Note that the effects of the present invention is presumably due to the current collector having a structure of a porous body with interconnected pores. Thus, effects similar to those of the above Examples can presumably be obtained, even when a porous body of aluminum alloy is used as the positive electrode current collector and a porous body of copper alloy is used as the negative electrode current collector.

### INDUSTRIAL APPLICABILITY

The LIC of the present invention can be applied to various electricity storage devices, since it has sufficiently increased capacity and high energy density and is capable of easy pre-doping of lithium.

### REFERENCE SIGNS LIST

1 resin foam
2 Al layer
3 Al porous body
10 cell case
11 positive electrode
11a positive electrode current collector
11b positive electrode active material
12 negative electrode
12a negative electrode current collector
12b negative electrode active material
13 separator
14 metal support
15 lithium metal
16 lead wire

1. A lithium-ion capacitor comprising:
a positive electrode having a positive electrode active material and a positive electrode current collector holding the positive electrode active material;
a negative electrode having a negative electrode active material and a negative electrode current collector holding the negative electrode active material; and
a non-aqueous electrolyte having lithium ion conductivity,
at least one selected from the positive electrode current collector and the negative electrode current collector being a porous body having interconnected pores, a porosity of the porous body being over 30% and 98% or less,
the interconnected pores being filled with the positive electrode active material or the negative electrode active material, the positive electrode active material or the negative electrode active material being configured to reversibly carry lithium,
at least one selected from the positive electrode active material and the negative electrode active material being pre-doped with lithium, and
the lithium pre-doped into the negative electrode active material being, in whole or in part, pre-doped from lithium electrochemically connected to the negative electrode, directly or after passing through at least one or more of the positive electrodes.

2. The lithium-ion capacitor in accordance with claim 1, wherein a ratio of a capacity Cn of the negative electrode to a capacity Cp of the positive electrode: Cn/Cp is 1.2 to 10.

3. The lithium-ion capacitor in accordance with claim 1, wherein the porosity is 80% to 98%.

4. The lithium-ion capacitor in accordance with claim 1, wherein the porous body has a three-dimensional mesh-like structure.

5. The lithium-ion capacitor in accordance with claim 4,
wherein the positive electrode current collector is the porous body having the three-dimensional mesh-like structure comprising aluminum or aluminum alloy, and
the negative electrode current collector is the porous body having the three-dimensional mesh-like structure comprising copper or copper alloy.

6. The lithium-ion capacitor in accordance with claim 1, wherein the negative electrode active material is pre-doped with the lithium in an amount corresponding to 90% or less of the difference between the capacity Cn of the negative electrode and the capacity Cp of the positive electrode: Cn−Cp.
